(19) United States
(12) Patent Application Publication
(10) Pub. No.: US 2013/0280019 A1
(43) Pub. Date: Oct. 24, 2013

(54) GRAIN CART SEED TENDER

(71) Applicant: Leon Dekoning, Hayter (CA)

(72) Inventor: Leon Dekoning, Hayter (CA)

(21) Appl. No.: 13/451,511

(22) Filed: Apr. 19, 2012

(51) Int. Cl. B60P 1/42

(52) U.S. Cl. 414/526

(57) ABSTRACT

A grain cart apparatus for transporting products to an air seeder cart has a tank with a bottom trough, and an auger conveyor extending under the trough and conveying products from the tank to an upright oriented discharge auger conveyor. Ports along the trough are opened and closed by valves. A partition wall divides the tank into front and rear portions and corresponding front and rear sets of ports. Front and rear valve actuators activate corresponding front and rear valves. Front and rear auger apertures are defined in a bottom wall of the horizontal auger under the front and rear sets of ports. A product conveyor is mounted under the horizontal auger such that products flowing through the ports and through the auger apertures enter the product conveyor and are carried to a product discharge at a rear end of the grain cart.

This invention is in the field of bulk transport equipment and in particular a grain cart for transporting seed and fertilizer to a seeding implement at seeding time, while not interfering with the typical use of the grain cart for receiving and transporting grains and like harvested crops from a combine at harvest time; and as well a drive wheel apparatus for supporting and maneuvering a conveyor on the grain cart, or a like object.

### BACKGROUND

Large grain carts carrying 1500 bushels of grain and often more are becoming popular for receiving grain and like harvested crops from a combine at harvest time and carrying same to a storage location or more often for transferring the grain to a highway transport vehicle. These grain carts are towed behind a tractor and work well for carrying large loads in agricultural fields that may be too soft to support a highway vehicle.

A typical larger size grain cart will have an elongated tank with sides sloping downward and inward to form a trough. A horizontal auger runs under the bottom of the tank from the front to the rear of the trough. Grain flows from the tank into the horizontal auger under the tank which conveys the grain to an upright auger at one end, typically the front end, of the grain cart and out the elevated discharge of the upright auger into a highway transport vehicle or into another desired location. Such a grain cart is disclosed for example in U.S. Pat. No. 6,488,114 to McMahon.

Valved ports are commonly provided in the bottom of the tank above the horizontal auger, and these ports are opened to allow grain to flow from the tank into the horizontal auger under the tank. Commonly the valves are provided by knife type valves, where a flat plate moves laterally to close an open port. In a large grain cart there may be several valved ports along the length of the bottom of the tank. The knife valves are connected so that the valves and opened and closed together by a hydraulic cylinder or like actuator.

When the tank is empty the ports are closed before more grain is deposited in the tank. This prevents grain from filling the horizontal auger while same is stationary. In this way the horizontal auger can be started while same is empty, thus reducing stress on the auger and drive. Once the horizontal auger is rotating the knife valves on the ports are opened and grain flows into the rotating horizontal auger and is conveyed out of the tank.

Such grain carts are costly and are commonly used only at harvest time and are idle for the rest of the year.

Air seeder carts are also being made larger in order to reduce the frequency of stopping seeding operations to fill the cart with agricultural products such as seed and fertilizer. Seed tenders are available for carrying agricultural products to air seeders. These tenders typically have a number of compartments for carrying different agricultural products such as seed, nitrogen fertilizer, phosphate fertilizer, potassium fertilizer, and the like. Commonly, air seeder carts include a cart conveyor for receiving agricultural products from a transport vehicle and carrying same into the desired separate compartments on the air seeder cart. Seed tenders typically include one or more conveyors or chutes to direct material from each tender compartment separately into the air seeder conveyor, or can include a conveyor that is operative to convey material from each compartment directly into the fill opening on top of each air seeder cart compartment.

These seed tenders however are also costly and used only during seeding and are then, like the grain carts, again idle for the rest of the year.

As air seeder carts get larger, the cart conveyors are also getting larger and so are more difficult to maneuver manually. Hydraulic cylinders and wheels are added to facilitate maneuvering these conveyors, however can be awkward to manipulate.

### SUMMARY OF THE INVENTION

It is an object of the present invention to provide a combination grain cart seed tender apparatus that overcomes problems in the prior art.

The present invention provides, in a first embodiment, a grain cart apparatus for use to transport agricultural products to an air seeder cart. The apparatus comprises an elongate tank with side walls sloping at lower portions thereof to a trough extending along a length of a bottom of the tank, the tank mounted on wheels for movement along the ground. A horizontal auger conveyor extends under the trough and is operative to convey agricultural products from the tank to an upright oriented discharge auger conveyor. A plurality of ports are defined along a length of the trough, and a valve is operative to open and close each port. A partition wall inside the tank divides the tank into front and rear tank portions, and the partition wall is positioned between ports such that a front set of ports is located under the front tank portion and a rear set of ports is located under the rear tank portion. A front valve actuator is operative to activate front valves on the front set of ports to open and close the front set of ports, and a rear valve actuator is operative to activate rear valves on the rear set of ports to open and close the rear set of ports. At least one front auger aperture is defined in a bottom wall of the horizontal auger under the front set of ports, and at least one rear auger aperture is defined in a bottom wall of the horizontal auger under the rear set of ports. A product conveyor is mounted under the horizontal auger such that agricultural products flowing through the ports and through the auger apertures enter the product conveyor and are carried to a product discharge at a rear end of the grain cart.

The present invention provides, in a second embodiment, a method of converting a grain cart for use to transport agricultural products to an air seeder cart, where the grain cart comprises an elongate tank with side walls sloping at lower portions thereof to a trough extending along a length of a bottom of the tank, a horizontal auger conveyor extending under the trough and operative to convey agricultural products from the tank forward to an upright oriented discharge auger conveyor, and a plurality of ports along a length of the trough, and a valve operative to open and close each port. The method comprises attaching a partition wall inside the tank to divide the tank into front and rear tank portions, wherein the partition wall is positioned between ports such that a front set of ports is located under the front tank portion and a rear set of ports is located under the rear tank portion; providing a front valve actuator operative to activate front valves on the front set of ports to open and close the front set of ports, and a rear valve actuator operative to activate rear valves on the rear set of ports to open and close the rear set of ports; providing at least one front auger aperture in a bottom wall of the horizontal auger under the front set of ports, and at least one rear auger aperture in a bottom wall of the horizontal auger under the rear set of ports; mounting a belt conveyor under the horizontal auger such that agricultural products flowing through the ports and through the auger apertures enters the belt conveyor and is carried to a product discharge at a rear end of the grain cart.

The grain cart seed tender of the invention can be used as a seed tender during the seeding season, and still used conventionally for receiving and transporting grain from a combine at harvest as originally intended.

The present invention provides, in a third embodiment, a drive wheel apparatus for maneuvering a supported body. The apparatus comprises a substantially vertical pivot shaft extending down from the supported body, and a pivot member rotatably mounted to the pivot shaft about a substantially vertical pivot axis. Right and left wheels are rotatably mounted to corresponding right and left sides of the pivot member about a substantially horizontal rotational axis. A right wheel control is operative to selectively activate a right wheel drive to rotate the right wheel forward and rearward, and a left wheel control is operative to selectively activate a left wheel drive to rotate the left wheel forward and rearward independent of the right wheel.

With the drive wheel apparatus of the present invention, the operator can then control movement of virtually any object that needs to be maneuvered. For example, in order to transfer agricultural products quickly, a transfer conveyor mounted to grain cart seed tender, or a cart conveyor mounted on an air seeder cart must have significant capacity, and therefore significant size and weight, making them cumbersome to maneuver. The drive wheel apparatus supports the weight and allows the operator to readily move the conveyor forward, rearward, or in a tight turn.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic top view of an embodiment of a grain cart apparatus of the present invention;

FIG. 2 is a schematic side view of the embodiment of FIG. 1;

FIG. 3 is a schematic sectional end view of the embodiment of FIG. 1;

FIG. 4 is a schematic top view of the grain cart of FIG. 1 with a transfer conveyor attached to a side thereof;

FIG. 5 is a schematic cutaway front view of an embodiment of a drive wheel apparatus of the present invention; and

FIG. 6 is a schematic front view of the embodiment of FIG. 5 with a joystick wheel control.

### DETAILED DESCRIPTION OF THE ILLUSTRATED EMBODIMENTS

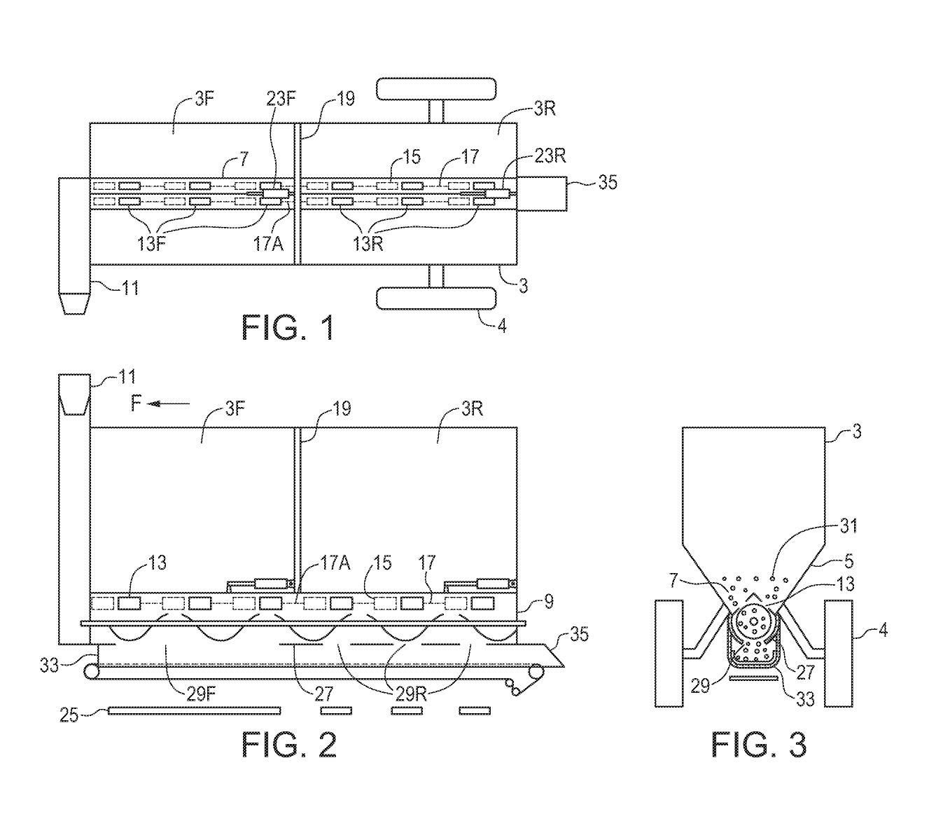

FIGS. 1-3 schematically illustrate a grain cart of the prior art that has been converted for use to effectively transport agricultural products to an air seeder cart by an embodiment of a method of the present invention.

The grain cart of the prior art comprises an elongate tank 3 with side walls 5 sloping at lower portions thereof to a trough 7 extending along a length of a bottom of the tank 3. The tank 3 is mounted on wheels 4 for movement along the ground as seen in FIG. 3. The wheels are not shown in FIG. 2 in order to facilitate clear viewing of the underside of the tank 3.

A horizontal auger conveyor 9 extends under the trough 7 and is operative to convey agricultural products from the tank 3 forward in direction F to an upright oriented discharge auger conveyor 11. A plurality of ports 13 are defined along a length of the trough 7, and a valve plate 15 is operative to open and close each port 13. The illustrated trough 7 is essentially a double trough as best seen in FIG. 3. The double trough 7 allows the horizontal auger conveyor 9 to be accessed from two sides. The ports 13 are defined on each side of the trough 7 thereof such that grain can flow into the horizontal auger 9 from two sides, facilitating and enhancing the flow of the grain into the horizontal auger conveyor 9.

The valve plates 15 move forward or rearward to open or close the ports 13. In a typical grain cart these valve plates are connected together by links 17 such that a single actuator moves all the plates 15 at the same time. The valve plates 15 are shown in the open position in phantom lines. In the original grain cart all the ports 13 from the front to the rear of the trough 7 open and close together, so that grain can flow out of the entire tank 3 and into the horizontal auger 9 at the same time.

The method of converting the grain cart of the prior art comprises attaching a partition wall 19 inside the tank 3 to divide the tank into front and rear tank portions 3F, 3R. The partition wall 19 is positioned between ports 13 such that a front set of ports 13F is located under the front tank portion 3F and a rear set of ports 13R is located under the rear tank portion 3R.

In the conversion process the link 17A that connects the valve plates 15 under the front valves 13F to the valve plates 15 under the rear valves 13R is cut and a second actuator 23 is provided. In the illustrated grain cart, the original actuator 23 is attached to the rear wall and in the conversion process becomes actuator 23R operative to activate rear valve plates 15 on the rear set of ports 13R to open and close the rear set of ports 13R. The second actuator 23 is attached to the partition wall and becomes actuator 23F operative to activate front valve plates 15 on the front set of ports 13F to open and close the front set of ports 13F.

The actuators 23F, 23R are provided by hydraulic cylinders with separate controls such that the valve plates 15 under the front and rear sets of ports 13F, 13R can be independently opened and closed. When used as a grain cart, the hydraulic supply to the front and rear actuators can be connected so that again, all ports are opened and closed together.

Auger apertures 27 are cut in the bottom wall of the tube 29 of the horizontal auger 9 to allow agricultural products 31 to flow from the tank 3 through the ports 13 into the auger tube 27 of the horizontal auger conveyor 9, and then out of the tube 27 and into a separate product conveyor 33 mounted under the horizontal auger 9. A front auger aperture 29F is located under the front set of ports 13F, and a rear auger aperture 29R is located in the bottom wall of the horizontal auger under the rear set of ports 13R. In the illustrated grain cart, the front auger aperture 29F is shown as a single aperture extending along the horizontal auger tube 27 under ports of the set of front ports 13F, while the rear auger aperture 29R is shown as separate auger apertures 29R, each located under a corresponding one of the set of rear ports 13R. It is contemplated that either arrangement will perform the required function, so long as each auger aperture has a length sufficient to allow agricultural products to flow through the auger tube 27 when the ports 13 are open.

It is contemplated that for ease of cleaning and installation the product conveyor 33 will most often be a belt conveyor, but an auger or pneumatic conveyor may also be used in some situations. The product conveyor 33 is operative to receive agricultural products 31 flowing through the ports 13 and through the auger apertures 13 and to convey the received agricultural products to a discharge 35 at a rear end of the grain cart.

Thus in operation, two different agricultural products, such as seed and fertilizer are placed into each of the front and rear tank portions 3F, 3R. When it is desired to transfer product from the front tank portion 3F to an air seeder cart, the product conveyor 33 is started and the front actuator 23F is activated to open the front set of ports 13F. The product in the front tank portion 3F then flows through the ports 13F, through the horizontal auger 9 and out through the front auger aperture 29 in the tube 27 of the horizontal auger 9 onto the belt of the product conveyor and is discharged at the discharge 35 into an air seeder cart conveyor or the like for carriage up into the air seeder cart compartments. When the desired amount of product has been transferred from the front tank portion, the front actuator 23F is activated to close the front set of ports 13F, the product conveyor 33 is operated until empty. The air seeder cart conveyor can be repositioned to discharge into different air seeder compartment, and the rear actuator is activated to open the rear set of ports 13R, and similarly transfer product from the rear tank portion 3R to the different compartment on the air seeder cart.

The auger apertures 29 are simply left open at all times when the converted grain cart is being used for seeding purposes. Removable cover plates 25 are operative to cover the front and rear auger apertures and close the auger apertures 29 when it is desired to use the horizontal auger 9 conventionally during harvest for hauling crop from a combine. It is contemplated alternatively that the auger apertures could be left open, such that the product belt conveyor 33 would be filled with harvested product. Once the product belt conveyor 33 is filled, the auger 9 would be able to operate normally, however considerable excess weight would be carried, and added stress put on the product belt conveyor 33.

It is readily seen that further partition walls and port valve actuators could be installed to provide three, four, or more separate compartments in the tank 3 to carry a further variety of separate agricultural products as might be desired.

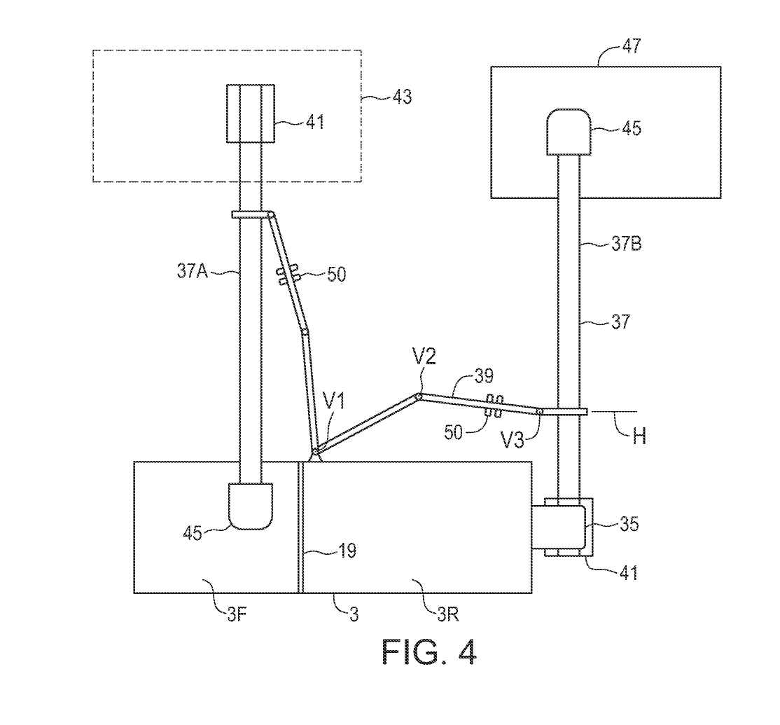

FIG. 4 schematically illustrates a transfer conveyor 37 pivotally attached to the grain tank 3 by inner and outer support arms 39. The attachment can be directly to the tank 3 or to the grain cart frame to which the grain tank 3 is also attached. The support arms 39 are pivotally connected to each other about a substantially vertical middle pivot axis V2. The inner end of the inner support arm is pivotally connected to the grain tank about a substantially vertical inner pivot axis V1, and an outer end of the outer support arm is pivotally connected to the transfer conveyor 37 about an outer vertical pivot axis V3 and about an outer horizontal pivot axis H.

The illustrated arrangement allows the transfer conveyor 37 to be oriented in first position 37A where the intake end 41 of the transfer conveyor 37 is located under a transport vehicle 43 to receive agricultural products from the transport vehicle 43 and the discharge end 45 thereof is located to discharge received agricultural products from the transport vehicle 43 into one of the front and rear tank portions 3F, 3R. The transfer conveyor 37 can also be oriented in second position 37B where the intake end 41 of the transfer conveyor 37 is located under the product conveyor discharge 35 and the discharge end 45 thereof is located to discharge received agricultural products from the tank 3 into an air seeder cart compartment 47.

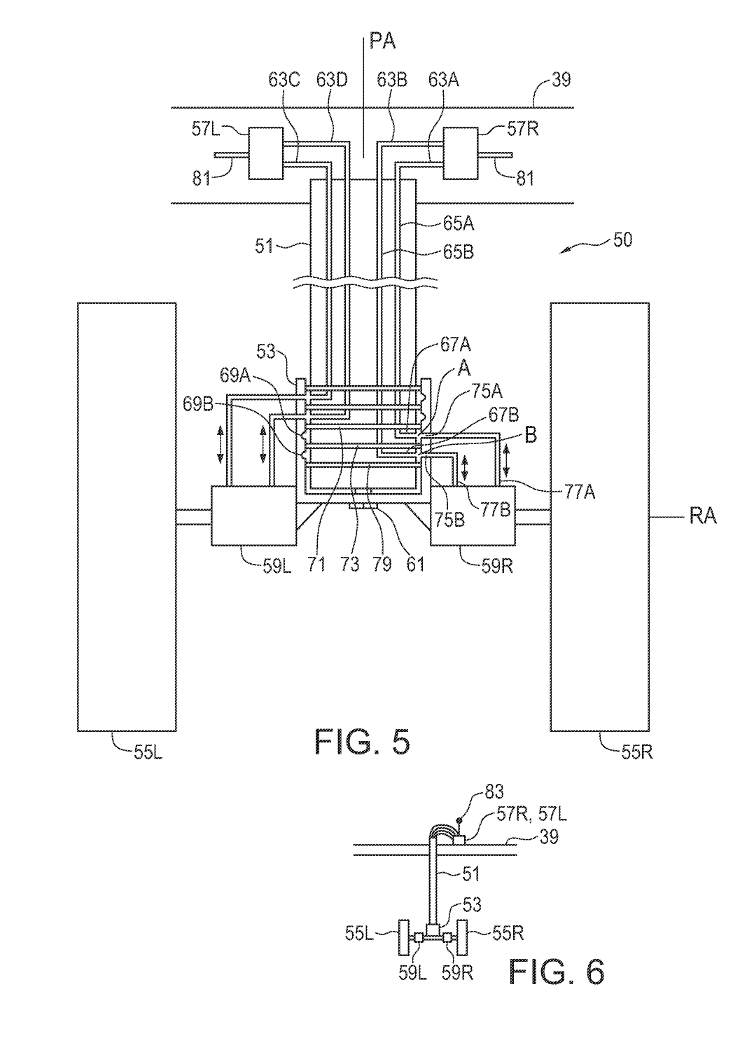

For even greater versatility and convenience of operation, the transfer conveyor could be a telescoping conveyor such as is described in U.S. Pat. No. 6,805,229 to Dekoning. Wheels and hydraulic cylinder actuators can be provided to facilitate maneuvering the transfer conveyor 37 as required. In the illustrated apparatus, the inner and outer arms 39 are supported on a drive wheel apparatus 50 as illustrated in FIGS. 5 and 6.

The drive wheel apparatus 50 comprises a substantially vertical pivot shaft 51 extending down from one of the inner and outer arms 39, and a pivot member, illustrated as a sleeve 53, rotatably mounted to the pivot shaft 51 about a substantially vertical pivot axis PA.

Right and left wheels 55R, 55L are rotatably mounted to corresponding right and left sides of the sleeve 53 about a substantially horizontal rotational axis RA. A right wheel control 57R is operative to selectively activate a right wheel drive, illustrated as right hydraulic motor 59R, to rotate the right wheel 55R forward and rearward. A left wheel control 57L is operative to selectively activate a left wheel drive, illustrated as left hydraulic motor 59L to rotate the left wheel 55L forward and rearward independent of the right wheel 55R.

In the illustrated apparatus 50 the right and left wheel drives are provided by corresponding right and left hydraulic motors 59R, 59L, and the right and left wheel controls 57R, 57L are mounted on one of the inner and outer arms 39 and are operative to direct pressurized hydraulic fluid to the corresponding right and left hydraulic motors 59R, 59L.

The bottom end of the pivot shaft 51 is rotatably engaged in the sleeve 53 and secured by a bolt 61 or other conventional means, such that the shaft 51 rotates in the sleeve 53 about the vertical pivot axis PA. The pivot shaft 51 defines conduits 63 connecting corresponding right and left wheel controls 57R, 57L to the right and left hydraulic motors 59R, 59L through the sleeve 53.

In the illustrated apparatus 50 a first and second conduits 63A, 63B connect the right hydraulic motor 59R to the right wheel control 57R.

The first conduit 63A comprises a first vertical bore 65A extending downward through the pivot shaft 51 from a top end thereof and a first lateral bore 67A extending laterally from an outer surface of the pivot shaft 51 at a first vertical location A to intersect the first vertical bore 65A. A first groove 69A is defined along an inner surface of the sleeve 53 at the first vertical location A such that the first lateral bore 67A connects to the first groove 69A. A first upper seal 71, typically for example an o-ring, is positioned above the first groove 69A and a first lower seal 73 is positioned below the first groove 69A and are operative to seal the outer surface of the pivot shaft 51 to the inner surface of the sleeve 53. A first channel 75A extends through a wall of the sleeve 53 from an outer surface of the sleeve 53 to the first groove 69A and a first hose 77A connects the first channel 75A to a first port on the right hydraulic motor 59R.

Thus pressurized hydraulic fluid can pass from the right wheel control 57R through vertical bore 65A to the lateral bore 67A and out into the groove 69A and from there through the channel 75A into the hose 77A to the port 79A on the hydraulic motor 59R. No matter where the sleeve 53 is positioned with respect to the shaft 51 about the vertical pivot axis PA, the hydraulic fluid will pass from the lateral bore 67A between the seals 71 and 73 along the groove 69B to the channel 75A.

In the same manner the second conduit 63B comprises a second vertical bore 65B extending downward through the pivot shaft 51 from a top end thereof and a second lateral bore 67B extending laterally from an outer surface of the pivot shaft 51 at a second vertical location B to intersect the second vertical bore 65A. A second groove 69B is defined along an inner surface of the sleeve 53 at the second vertical location B such that the second lateral bore 67B connects to the second groove 69A. The first lower seal 73 above the second groove 69B and second lower seal 79 below the second groove 69B are operative to seal the outer surface of the pivot shaft 51 to the inner surface of the sleeve 53. A second channel 75B extends through a wall of the sleeve 53 from an outer surface of the sleeve 53 to the second groove 69B and a second hose 77B connects the second channel 75B to a second port on the right hydraulic motor 59R.

Similarly conduits 63C and 63D connect the left wheel control 57L to the left hydraulic motor 59L. The operator can then control movement of the transfer conveyor 37, or any other body supported by the apparatus 50 by manipulating the right and left wheel controls 57R, 57L. Both wheels can be rotated in the same direction, either forward or reverse, and also one can be rotated faster or slower, or in the opposite direction, to make a turn. The apparatus 50 would, for example, be suited to manipulate the conveyors that are typically mounted on air seeder carts to load agricultural products into the cart. As air seeder carts get larger, these conveyors are also getting larger and so are more difficult to maneuver manually.

The controls 57R, 57L shown in FIG. 5 require that the operator keep a hand on each control lever 81. For improved convenience FIG. 6 shows an apparatus where the controls 57R, 57L are combined and controlled by a joystick lever 83, such as is known in the hydraulic art, which requires only one hand to operate.

Thus a grain cart of the prior art can be converted to use as a seed tender, while not interfering with the use of the same conventionally to receive grain from a combine at harvest—the partitions walls reduce capacity very marginally, and the front and rear valve actuators can be hydraulically connected to operate as one, or can be operated individually. The period of use of the grain cart is greatly extended and the high capacity of the conventional grain cart is well used for transporting agricultural products to similarly large air seeder carts.

It is also contemplated that a grain cart could be converted at the factory or manufactured to provide a combination grain cart seed tender as described herein.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A grain cart apparatus for use to transport agricultural products to an air seeder cart, the apparatus comprising:
an elongate tank with side walls sloping at lower portions thereof to a trough extending along a length of a bottom of the tank, the tank mounted on wheels for movement along the ground;
a horizontal auger conveyor extending under the trough and operative to convey agricultural products from the tank to an upright oriented discharge auger conveyor;
a plurality of ports along a length of the trough, and a valve operative to open and close each port;
a partition wall inside the tank dividing the tank into front and rear tank portions, wherein the partition wall is positioned between ports such that a front set of ports is located under the front tank portion and a rear set of ports is located under the rear tank portion;
a front valve actuator operative to activate front valves on the front set of ports to open and close the front set of ports, and a rear valve actuator operative to activate rear valves on the rear set of ports to open and close the rear set of ports;
at least one front auger aperture in a bottom wall of the horizontal auger under the front set of ports, and at least one rear auger aperture in a bottom wall of the horizontal auger under the rear set of ports; and
a product conveyor mounted under the horizontal auger such that agricultural products flowing through the ports and through the auger apertures enter the product conveyor and are carried to a product discharge at a rear end of the grain cart.

2. The apparatus of claim 1 wherein the product conveyor comprises a belt conveyor.

3. The apparatus of claim 1 wherein at least one of the front and rear valve actuators comprises a hydraulic cylinder.

4. The apparatus of claim 3 wherein the front and rear actuators are provided by front and rear hydraulic cylinders, and wherein in a air seeder cart mode the front and rear hydraulic cylinders are connected to separate hydraulic controls such that the valve plates under the front and rear sets of ports are independently opened and closed, and wherein in a grain cart mode the front and rear hydraulic cylinders are connected to the same hydraulic control such that the valve plates under the front and rear sets of ports are opened and closed together.

5. The apparatus of claim 1 comprising removable cover plates operative to cover the front and rear auger apertures and close the auger apertures.

6. The apparatus of claim 1 comprising a transfer conveyor pivotally attached to the grain tank and movable from a first position, where an intake end of the transfer conveyor is located under a transport vehicle to receive agricultural products from the transport vehicle and a discharge end thereof is located to discharge received agricultural products from the transport vehicle into one of the front and rear tank portions, to a second position where, the intake end of the transfer conveyor is located under the product conveyor discharge and the discharge end thereof is located to discharge received agricultural products from the tank into a compartment of an air seeder cart.

7. The apparatus of claim 6 wherein the transfer conveyor is pivotally attached to the grain tank by inner and outer support arms, wherein the inner and outer support arms are pivotally connected to each other about a substantially vertical middle pivot axis, an inner end of the inner support arm is pivotally connected to the grain cart about a substantially vertical inner pivot axis, and an outer end of the outer support arm is pivotally connected to the transfer conveyor about an outer vertical pivot axis and about an outer substantially horizontal pivot axis.

8. The apparatus of claim 7 wherein the inner and outer arms are supported on a wheel.

9. The apparatus of claim 8 comprising a drive wheel apparatus comprising;
a substantially vertical pivot shaft extending down from one of the inner and outer arms, and a pivot member rotatably mounted to the pivot shaft about a substantially vertical pivot axis;
right and left wheels rotatably mounted to corresponding right and left sides of the pivot member about a substantially horizontal rotational axis;
a right wheel control operative to selectively activate a right wheel drive to rotate the right wheel forward and rearward; and
a left wheel control operative to selectively activate a left wheel drive to rotate the left wheel forward and rearward independent of the right wheel.

10. The apparatus of claim 9 wherein the right and left wheel drives are provided by corresponding right and left hydraulic motors, and wherein the right and left wheel controls are mounted on one of the inner and outer arms and are operative to direct pressurized hydraulic fluid to the corresponding right and left hydraulic motors.

11. The apparatus of claim 10 wherein the pivot member comprises a sleeve and wherein a bottom end of the pivot shaft is rotatably engaged in the sleeve.

12. The apparatus of claim 11 wherein the pivot shaft defines conduits connecting corresponding right and left wheel controls to the right and left hydraulic motors through the sleeve.

13. A method of converting a grain cart for use to transport agricultural products to an air seeder cart, where the grain cart comprises an elongate tank with side walls sloping at lower portions thereof to a trough extending along a length of a bottom of the tank, a horizontal auger conveyor extending under the trough and operative to convey agricultural products from the tank forward to an upright oriented discharge auger conveyor, and a plurality of ports along a length of the trough, and a valve operative to open and close each port; the method comprising:
attaching a partition wall inside the tank to divide the tank into front and rear tank portions, wherein the partition wall is positioned between ports such that a front set of ports is located under the front tank portion and a rear set of ports is located under the rear tank portion;
providing a front valve actuator operative to activate front valves on the front set of ports to open and close the front set of ports, and a rear valve actuator operative to activate rear valves on the rear set of ports to open and close the rear set of ports;
providing at least one front auger aperture in a bottom wall of the horizontal auger under the front set of ports, and at least one rear auger aperture in a bottom wall of the horizontal auger under the rear set of ports; and
mounting a belt conveyor under the horizontal auger such that agricultural products flowing through the ports and through the auger apertures enters the belt conveyor and is carried to a product discharge at a rear end of the grain cart.

14. The method of claim 13 comprising providing a transfer conveyor movable from a first position, where an intake end of the transfer conveyor is located under a transport vehicle to receive agricultural products from the transport vehicle and a discharge end thereof is located to discharge received agricultural products from the transport vehicle into one of the front and rear tank portions, to a second position, where the intake end of the transfer conveyor is located under the product conveyor discharge and the discharge end thereof is located to discharge received agricultural products from the tank into a compartment of an air seeder cart.

15. A drive wheel apparatus for maneuvering a supported body, the apparatus comprising:
a substantially vertical pivot shaft extending down from the supported body, and a pivot member rotatably mounted to the pivot shaft about a substantially vertical pivot axis;
right and left wheels rotatably mounted to corresponding right and left sides of the pivot member about a substantially horizontal rotational axis;
a right wheel control operative to selectively activate a right wheel drive to rotate the right wheel forward and rearward; and
a left wheel control operative to selectively activate a left wheel drive to rotate the left wheel forward and rearward independent of the right wheel.

16. The apparatus of claim 15 wherein the right and left wheel drives are provided by corresponding right and left hydraulic motors, and wherein the right and left wheel controls are mounted on the supported body and are operative to direct pressurized hydraulic fluid to the corresponding right and left hydraulic motors.

17. The apparatus of claim 16 wherein the pivot member comprises a sleeve and wherein a bottom end of the pivot shaft is rotatably engaged in the sleeve.

18. The apparatus of claim 17 wherein the shaft defines conduits connecting corresponding right and left wheel controls to the right and left hydraulic motors through the sleeve.

19. The apparatus of claim 18 wherein:
a first conduit comprises:
a first vertical bore extending downward through the pivot shaft from a top end thereof and a first lateral bore extending laterally from an outer surface of the pivot shaft at a first vertical location to intersect the first vertical bore; and
a first groove along an inner surface of the sleeve at the first vertical location such that the first lateral bore connects to the first groove;
a first upper seal above the first groove operative to seal the outer surface of the pivot shaft to the inner surface of the sleeve;
a first lower seal below the first groove operative to seal the outer surface of the pivot shaft to the inner surface of the sleeve;
a first channel from an outer surface of the sleeve to the first groove; and
a first hose connecting the first channel to a first port on the right hydraulic motor;
a second conduit comprises:
a second vertical bore extending downward through the pivot shaft from a top end thereof and a second lateral bore extending laterally from the outer surface of the pivot shaft at a second vertical location to intersect the second vertical bore, wherein the second vertical location is below the first vertical location; and
a second groove along the inner surface of the sleeve at the second vertical location such that the second lateral bore connects to the second groove;
a second upper seal above the second groove operative to seal the outer surface of the pivot shaft to the inner surface of the sleeve; and
a second lower seal below the second groove operative to seal the outer surface of the pivot shaft to the inner surface of the sleeve;
a second channel from an outer surface of the sleeve to the second groove; and
a second hose connecting the second channel to a second port on the right hydraulic motor.

20. The apparatus of claim 19 wherein the first lower seal and the second upper seal are provided by an o-ring between the first and second grooves.

21. The apparatus of claim 16 wherein the right and left wheel controls are operated by a joystick control lever.
